(19) United States
(12) Patent Application Publication
(10) Pub. No.: US 2020/0242706 A1
(43) Pub. Date: Jul. 30, 2020

(54) METHOD AND APPARATUS FOR PROCESSING TRANSACTION REQUESTS

(71) Applicant: ALL FOR YOU TECHNOLOGY (GUANGZHOU) CO., LTD, Guangzhou (CN)

(72) Inventors: Xudong Cui, Guangzhou (CN); Fenghua Hui, Guangzhou (CN); Dong Qiu, Xi'an (CN)

(21) Appl. No.: 16/747,468

(22) Filed: Jan. 20, 2020

(30) Foreign Application Priority Data
Jan. 30, 2019 (CN) 201910094151.0

(51) Int. Cl. G06Q 50/00; G06Q 30/02; G07C 13/00; G06Q 20/12

(52) U.S. Cl. CPC G06Q 50/01; G06Q 20/12; G07C 13/00; G06Q 30/0283

(57) ABSTRACT

Disclosed are a method and an apparatus for matching between a transaction request and a response based on location of a transaction, wherein the method comprises: step S1: receiving, by a server, a transaction request from a first client, the transaction request including a transaction description, an upfront pricing for the transaction, location of the transaction, and a posting scope associated with the location of the transaction; step S2: after a receiver in the server successfully receives the upfront pricing for the transaction transferred from the first client, positioning, via a Location Based Service (LBS), locations of other clients based on the location of the transaction, and pushing the transaction request to a plurality of second clients within the posting scope; step S3: receiving, from one or more of the plurality of second clients, one or more responses to the request, and forwarding the one or more responses to the first client to implement matching. The present disclosure provides a method for matching and responding to an emergent and trivial transaction request, which enables a user to obtain a faster and more professional help.

### CROSS-REFERENCE TO RELATED APPLICATIONS

This application claims priority to China Patent Application No. CN201910094151.0, filed on Jan. 30, 2019. China Patent Application No. CN201910094151.0 is hereby incorporated by reference herein in its entirety.

### FIELD

Embodiments of the present disclosure generally relate to the technical field of computer networks, and more particularly relate to a method and an apparatus for processing a transaction request.

### BACKGROUND

In recent years, urban development witnesses emergence of community services. Nowadays, services are always provided within a certain scope, e.g., a community. The concept of “fragmented time utilization,” which is also recently proposed, refers to utilizing fragmented time of individuals to serve others, thereby enhancing operating efficiency of the whole society. In conventional transaction releasing platforms, e.g., the popular “58.com” subscribers are categorized into users and vendors, wherein the vendors post classified services such as domestic services, moving services, and home repair and maintenance services, etc. on a platform, while the users select eligible vendors on the platform based on their own needs.

On the conventional transaction releasing platforms, classifications are task-based and the services are posted by vendors based on their capabilities; therefore, there lacks a response mechanism for a user's emergency demand. Further, the services posted by vendors on the platforms are too professional, such that there lacks a response mechanism for a user's simple and trivial needs. For example, a kid suddenly gets a fever at midnight; unfortunately, no antipyretic drugs are available at home and the nearby drug stores are all closed. In this case, an antipyretic drug is urgently needed. If a parent logs in a conventional platform to search a drug store operating at midnight and then goes there to buy, a long time would be consumed and the fever fails to be relieved timely. For another example, when one goes outdoor and finds that his mobile phone has a very low battery and will be soon power off, he needs to find a charger to charge the mobile phone. Such demands are too trivial and too unprofessional, and no vendors on the conventional platforms provide such services. Therefore, the services provided on conventional platforms lack an efficient response mechanism to handle users' emergency demands and trivial demands.

### SUMMARY

In view of the above, the present disclosure provides a method and an apparatus for processing a transaction request. A first object of the present disclosure is to solve a problem that the processing progress of a transaction is prolonged in conventional methods for processing a transaction request or in conventional schemes generally with vendors as posters because it was time consuming for a user to search for a suitable service provider.

A second object of the present disclosure is to solve a problem that conventional transaction processing schemes only deal with professional matters. However, in reality, people always come across various trivial matters. To enlist professional servers on existing platforms for such trivial matters, first, it is a waste for social resources, and second, a simple task is charged based on a professional billing rate. In this case, because the conventional solutions for processing transaction requests fail to provide an efficient mechanism for trivial user demands, a user would either give up his service request or pay dearly to a professional for basic services.

To achieve the objects above, a technical solution of the present disclosure is implemented as such:

A first technical solution provides a method for matching between a transaction request and a response based on location of a transaction, comprising: step S1: receiving, by a server, a transaction request from a first client, the transaction request including a transaction description, an upfront pricing for the transaction, location of the transaction, and a posting scope associated with the location of the transaction; step S2: after a receiver in the server successfully receives the upfront pricing for the transaction transferred from the first client, positioning, via a Location Based Service (LB S), locations of other clients based on the location of the transaction, and pushing the transaction request to a plurality of second clients within the posting scope; step S3: receiving, from one or more of the plurality of second clients, one or more responses to the transaction request, and forwarding the one or more responses to the first client to implement matching.

A second technical solution is based on the first technical solution, wherein the upfront pricing for the transaction minus a certain percentage of platform fee is transferred to a matched second client upon completion of the transaction.

A third technical solution is based on the second technical solution, wherein before the step S1, the method further comprises: accepting a registration request from a client so as to create an account for the client.

A fourth technical solution is based on the third technical solution, wherein the registration request includes a user profile.

A fifth technical solution is based on the fourth technical solution, wherein the user profile includes any one of individual/institution license obtained by the user, gender, age, user's ID, or credit level, or any combination of the above.

A sixth technical solution is based on the fifth technical solution, wherein before creating an account for the user, the individual/institution license, gender, age, user's ID, or credit level, which are submitted by the user, are verified; in the case of pass, the registration succeeds; in the case of failure, the registration fails.

A seventh technical solution is based on any one of the first through sixth technical solutions, wherein the transaction description further includes a specific requirement.

An eighth technical solution is based on the seventh technical solution, wherein the specific requirement refers to a specific requirement on any aspect or any combination of more aspects in individual/institution license obtained by the user, gender, age, user's ID, or credit level, or any combination of the above.

A ninth technical solution is based on the eighth technical solution, wherein the second client is further required to meet the specific requirement.

A tenth technical solution is based on the first technical solution, wherein the location of the transaction refers to a location of the first client.

An eleventh technical solution is based on the tenth technical solution, wherein the location of the first client is directly obtained by the first client which enables a positioning function or is manually entered by the user of the first client.

A twelfth technical solution is based on the first technical solution, wherein the location of the transaction refers to a location specified in the transaction request.

A thirteenth technical solution is based on the first technical solution, wherein the step S3 further comprises forwarding a plurality of responses to the transaction request to the first client for selection.

A fourteenth technical solution is based on the first technical solution, wherein the step S3 further comprises detecting whether responding users include a user qualified for the transaction; if yes, forwarding the response from the qualified user to the first client for selection.

A fifteenth technical solution is based on the thirteenth technical solution or the fourteenth technical solution, wherein the step S3 further comprises: receiving a select response from the first client, and marking a status of the transaction request as Matched.

A sixteenth technical solution is based on the first technical solution, wherein the step S3 further comprises forwarding a first response to the transaction request to the first client.

A seventeenth technical solution is based on the sixteenth technical solution, wherein the step S3 further comprises: receiving an acknowledgment response from the first client, and marking the status of the transaction request as Matched.

An eighteenth technical solution is based on the fifteenth technical solution or the seventeenth technical solution, further comprising: after the status of the transaction request has been marked as Matched, receiving, from the first client, a request for modifying or canceling the transaction, and forwarding the request for modifying or canceling the transaction to the matched second client; receiving an acknowledgment message from the matched second client, modifying the transaction or marking the status of the transaction request as Canceled based on the acknowledgment message; or receiving, from the matched second client, a request for canceling the transaction, forwarding the request for canceling the transaction to the first client, receiving an acknowledgment message from the first client, and marking the status of the transaction request as Canceled.

A nineteenth technical solution is based on the fifteenth technical solution or the seventeenth technical solution, wherein after marking the status of the transaction request as Matched but before completion of the transaction, the method further comprises: receiving, from the first client, an additional payment supplemented to the transaction, and transferring a sum of the additional payment and the upfront pricing after minus a certain percentage of platform fee to the matched second client upon completion of the transaction.

A twentieth technical solution is based on any one of the fifteenth technical solution, the seventeenth technical solution, and the nineteenth technical solution, further comprising: after the status of the transaction request is Completed, receiving the additional payment supplemented by the first client.

A twenty-first technical solution is based on the first technical solution, wherein after the step S3, the method further comprises: receiving a dispute resolution request from the client, generating vote options based on the dispute resolution request, and pushing the vote options; receiving a voting result for all vote options; and determining a payment amount based on the voting result.

A twenty-second technical solution is based on the twenty-first technical solution, further comprising: paying a voting fee to a voting user, the voting fee being included in the upfront pricing for the transaction.

A twenty-third technical solution is based on the twenty-second technical solution, wherein the determining a payment amount comprises: if the voting result is that all votes support full-amount payment or full-amount refund, paying based on the voting result, wherein a dispute resolution request initiator bears the voting fee, or paying by the platform from the upfront pricing for the transaction minus the voting fee based on the voting result; if the voting result is neither supporting full-amount payment by all votes nor supporting full-amount refund by all votes, paying a certain percentage based on the voting result, wherein a responder of the transaction request bears the voting fee, or paying a certain percentage by the platform from the upfront pricing for the transaction minus the voting fee based on the voting result.

A twenty-fourth technical solution provides an apparatus for matching between a transaction request and a response based on location of a transaction, comprising: a first unit configured for receiving, by a server, a transaction request from a first client, the transaction request including a transaction description, an upfront pricing for the transaction, location of the transaction, and a posting scope associated with the location of the transaction; a second unit configured for: after a receiver in the server successfully receives the upfront pricing for the transaction transferred from the first client, positioning, via a Location Based Service (LB S), locations of other clients based on the location of the transaction, and pushing the transaction request to a plurality of second clients within the posting scope; and a third unit configured for receiving, from one or more of the plurality of second clients, one or more responses to the transaction request, and forwarding the one or more responses to the first client to implement matching.

A twenty-fifth technical solution is based on the twenty-fourth technical solution, wherein the upfront pricing for the transaction minus a certain percentage of platform fee is transferred to a matched second client upon completion of the transaction.

A twenty-sixth technical solution is based on the twenty-fifth technical solution, wherein the apparatus further comprises a fourth unit, the fourth unit being configured for accepting a registration request from a client so as to create an account for the client.

A twenty-seventh technical solution is based on the twenty-sixth technical solution, wherein the registration request includes a user profile.

A twenty-eighth technical solution is based on the twenty-seventh technical solution, wherein the user profile includes any one of individual/institution license obtained by the user, gender, age, user's ID, or credit level, or any combination of the above.

A twenty-ninth technical solution is based on the twenty-eighth technical solution, wherein before creating an account for the user, the individual/institution license obtained by the user, gender, age, user's ID, or credit level, which are submitted by the user, are verified; in the case of pass, the registration succeeds; in the case of failure, the registration fails.

A thirtieth technical solution is based on any one of the twenty-fourth through twenty-ninth technical solutions, wherein the transaction description further includes a specific requirement.

A thirty-first technical solution is based on the thirtieth technical solution, wherein the specific requirement refers to a specific requirement on any aspect or any combination of more aspects in individual/institution license obtained by the user, gender, age, user's ID, or credit level, or any combination of the above.

A thirty-second technical solution is based on the thirty-first technical solution, wherein in the second unit, the second client is further required to meet the specific requirement.

A thirty-third technical solution is based on the twenty-fourth technical solution, wherein the location of the transaction refers to a location of the first client.

A thirty-fourth technical solution is based on the thirty-third technical solution, wherein the location of the first client is directly obtained by the first client which enables a positioning function or is manually entered by the user of the first client.

A thirty-fifth technical solution is based on the twenty-fourth technical solution, wherein the location of the transaction refers to a location specified in the transaction request.

A thirty-sixth technical solution is based on the twenty-fourth technical solution, wherein the third unit is further configured for: forwarding a plurality of responses to the transaction request to the first client for selection.

A thirty-seventh technical solution is based on the twenty-fourth technical solution, wherein the third unit is further configured for: detecting whether responding users include a user qualified for the transaction; if yes, forwarding the response from the qualified user to the first client for selection.

A thirty-eighth technical solution is based on the thirty-sixth technical solution or the thirty-seventh technical solution, wherein the third unit is further configured for receiving a select response from the first client, and marking a status of the transaction request as Matched.

A thirty-ninth technical solution is based on the twenty-fourth technical solution, wherein the third unit is further configured for forwarding a first response to the transaction request to the first client.

A fortieth technical solution is based on the thirty-ninth technical solution, wherein the third unit is further configured for: receiving an acknowledgment response from the first client, and marking the status of the transaction request as Matched.

A forty-first technical solution is based on the thirty-eighth technical solution or the fortieth technical solution, wherein the third unit is further configured for: after the status of the transaction request has been marked as Matched, receiving, from the first client, a request for modifying or canceling the transaction, and forwarding the request for modifying or canceling the transaction to the matched second client; receiving an acknowledgment message from the matched second client, modifying the transaction or marking the status of the transaction request as Canceled based on the acknowledgment message; or receiving, from the matched second client, a request for canceling the transaction, forwarding the request for canceling the transaction to the first client, receiving an acknowledgment message from the first client, and marking the status of the transaction request as Canceled.

A forty-second technical solution is based on the thirty-eighth technical solution or the fortieth technical solution, wherein after marking the status of the transaction request as Matched but before completion of the transaction, the third unit is further configured for: receiving, from the first client, an additional payment supplemented to the transaction, and transferring a sum of the additional payment and the upfront pricing after minus a certain percentage of platform fee to the matched second client upon completion of the transaction.

A forty-third technical solution is based on any one of the thirty-eighth technical solution, the fortieth technical solution, and the forty-second technical solution, wherein after the status of the transaction request is Completed, the additional payment supplemented by the first client is received.

A forty-fourth technical solution is based on the twenty-fourth technical solution, further comprising a fifth unit, the fifth unit including: a first subunit configured for receiving a dispute resolution request from the client; a second subunit configured for generating vote options based on the dispute resolution request, and pushing the vote options; and a third subunit configured for receiving a voting result for all vote options and determining a payment amount based on the voting result.

A forty-fifth technical solution is based on the forty-fourth technical solution, a voting fee is paid to a voting user, the voting fee being included in the upfront pricing for the transaction.

A forty-sixth technical solution is based on the forty-fourth technical solution or the forty-fifth technical solution, wherein the determining a payment amount comprises: if the voting result is that all votes support full-amount payment or full-amount refund, paying based on the voting result, wherein the dispute resolution request initiator bears the voting fee, or paying by the platform from the upfront pricing for the transaction minus the voting fee based on the voting result; if the voting result is neither supporting full-amount payment by all votes nor supporting full-amount refund by all votes, paying a certain percentage based on the voting result, wherein a responder of the dispute resolution request bears the voting fee, or paying a certain percentage by the platform from the upfront pricing for the transaction minus the voting fee based on the voting result.

A forty-seventh technical solution provides a server for matching between a transaction request and a response based on location of a transaction, comprising: a memory; a processor coupled to the memory, wherein the processor is configured for executing, based on an instruction stored in the memory, the method according to any one of the first technical solution through the twenty-third technical solution.

A forty-eighth technical solution provides a computer-readable storage medium on which a computer program instruction is stored, wherein the instruction, when being executed by one or more processors, implements operations of the method according to any one of the first technical solution through the twenty-third technical solution.

The present disclosure offers the following advantages and beneficial effects: the method and the corresponding apparatus for matching between a transaction request and a response based on location of a transaction according to the present disclosure enables a user to serve both as a transaction request initiator and as a transaction request responder; besides, the present disclosure also enables posting of a service request to users within a posting scope set by the transaction request initiator such that a user nearby may accept the request to carry out a tight-time request task; as a registered user may be an individual or a specialized agency, some transaction services without a higher demand on professional level may resort to a common user eligible to offer service, thereby saving social resources and avoiding paying dearly to professional service provider for dealing with a simple task.

### BRIEF DESCRIPTION OF THE DRAWINGS

FIG. 1 shows a schematic diagram of a network architecture adopted by the technical solution of the present disclosure;

FIG. 2 shows a flow diagram of a method for matching between a transaction request and a response according to an embodiment of the present disclosure;

FIG. 3 shows a flow diagram of a method for matching between a transaction request and a response according to another embodiment of the present disclosure;

FIG. 4 shows a flow diagram of a dispute resolution mechanism after step 3 according to a yet another embodiment of the present disclosure;

FIG. 5 shows a structural diagram of an apparatus for matching between a transaction request and a response according to another aspect of the present disclosure;

FIG. 6 shows a structural diagram of an apparatus for matching between a transaction request and a response according to a yet another aspect of the present disclosure;

FIG. 7 shows a structural diagram of a fifth unit of an apparatus for matching between a transaction request and a response according to a further aspect of the present disclosure;

FIG. 8 shows a structure of a server according to an embodiment of the present disclosure; and

FIG. 9 shows a program product according to an embodiment of the present disclosure.

### DETAILED DESCRIPTION OF EMBODIMENTS

Hereinafter, preferred embodiments of the present disclosure will be illustrated in detail with reference to the accompanying drawings; the reference numerals represent compositions and technologies in the present disclosure, such that implementation of the advantages and features of the present disclosure is more easily understood in a suitable environment. What will be described hereinafter are specific implementations of the claims of the present disclosure, and other specific implementations which are related to the claims but not explicitly described also fall into the scope of the claims. Meanwhile, it should be understood that for ease of depiction, the scales of various parts shown in the drawings are not drawn according to practical proportional relationships. The depictions on at least one exemplary embodiment below are only illustrative, and in no way intended to limit the present disclosure or application or use thereof.

Those technologies, methods and apparatuses known to those skilled in the art might not be discussed in detail, but in appropriate circumstances, such technologies, methods and apparatuses shall be regarded as part of the description.

Embodiments of the present disclosure may be applied to a computer system/server, which may be operated with a plurality of other universal or specific computing system environments or configurations. Examples of known computing systems, environments and/or configurations used together with the computer systems/servers include, but not limited to, a smart phone, a personal computer system, a server computer system, a thin client, a thick client, a handheld or laptop device, a microprocess-based system, a set-top box, a programmable consumption electronic product, a network personal computer, a micro computer system, a large computer system, and a distributed cloud computing technology environment including any of the above systems, etc.

The computer system/server may be described in a general context of a computer system executable instruction (e.g., a program module) executed by the computer system. Generally, the program module may include a routine, a program, a target program, a component, a logic, and a data structure, etc., which executes a specific task or implements a specific abstract data structure. The computer system/server may be implemented in a distributed cloud computing environment where the task is executed by a remote processing device linked via a communication network. In the distributed cloud computing environment, the program module may be disposed on a local or remote computing system storage medium of the memory device.

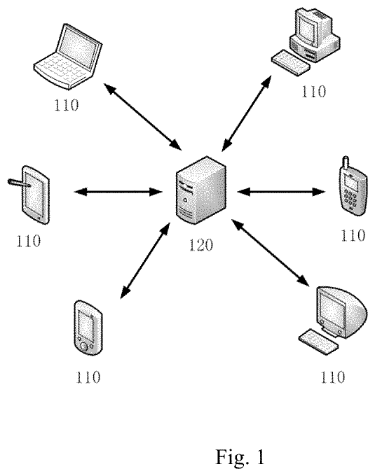

FIG. 1 shows a schematic diagram of a network architecture adopted by the technical solution of the present disclosure.

As shown in FIG. 1, the system adopted by the present disclosure may comprise: a user terminal 110 and a server 120. Communication and messaging are enabled between the user terminal and the server 120. Types of messages include, but are not limited to, a text, a document, a voice, an expression, a picture, an audio, a video, and any combination thereof.

As shown in FIG. 1, the user terminal 110 of the present disclosure may refer to any one or more of a personal computer (PC), a laptop computer, a tablet computer, a personal digital assistant, iMac, and a smart phone. These terminals 110 may include any suitable operating system, including, but not limited to, Windows, Linux, Android, iOS, etc. The client terminals may be fixed, e.g., fixed communication devices located in households, offices, and Internet café, or may be disposed on other mobile platforms, e.g., disposed on the platforms such as automobiles, trains, aircrafts, etc. The user terminal 110 may be connected to various servers or cloud ends via a wired network, a wireless network, or a combination thereof. The wireless network includes, but not limited to, a mobile telephone network, a local area network (LAN), a Bluetooth personal area network, a Wi-Fi, an Ethernet network, a token ring, a wide area network, and the Internet, etc. The wired network includes, but not limited to, a telephone line network, an optical fiber cable line network, a cable line network, a cable television network, etc.

The server 120 may adopt any commercial or dedicated server, which is not limited herein. The present disclosure may re-design the server 120, e.g., redesigning the program in the server, etc.

Besides, the user terminal 110 of the present disclosure may be connected to a new user terminal, e.g., directly connected to other user terminal via Bluetooth and a data cable. The new user terminal, for example, may be a wearable device, a mobile phone, etc. The present disclosure does not make any limitation to the type of the user terminal.

FIG. 2 shows a flow diagram of a method for matching between a transaction request and a response according to an embodiment of the present disclosure.

As shown in FIG. 2, the method according to the present disclosure comprises: step S1: receiving, by a server, a transaction request from a first client, the transaction request including a transaction description, an upfront pricing for the transaction, location of the transaction, and a posting scope associated with the location of the transaction; step S2: after a receiver in the server successfully receives the upfront pricing for the transaction transferred from the first client, positioning, via a Location Based Service (LB S), locations of other clients based on the location of the transaction, and pushing the transaction request to a plurality of second clients within the posting scope; step S3: receiving, from one or more of the plurality of second clients, one or more responses to the transaction request, and forwarding the one or more responses to the first client to implement matching.

In the present disclosure, the transaction description included in the transaction request may refer to a description of a difficulty or a desired service, which needs to explicitly describe the service desired by the user and the mental or physical workload needed for providing the service under the condition. For example, a user's car breaks down on a roadside such that a car repair help is needed; then the transaction may be described as “my car broke down on a roadside”; if the car is just refueled, the transaction may be further described as “just refueled, excluding the cause of out of fuel”; meanwhile, he may also fill out the car model and the condition, e.g., “Toyota Corolla 2010, no repair tools.” Before the user posts the transaction request to the platform, he/she needs to fill out, on his/her own, the transaction description and the upfront pricing for the transaction; the user may edit the transaction description; a specific fill-out box may be set for the upfront pricing for the transaction to facilitate subsequently identifying an entered value so as to debit a correct amount of the upfront pricing from the user account. If the fee which is willing to be paid and filled out by the user in the transaction description is different from the number entered in the upfront pricing fill-out box, the number in the upfront pricing fill-out box shall govern. For example, the user describes the transaction as “toilet dredging for a household in Complex A, 200 CNY for compensation,” while the number entered by the user in the upfront pricing fill-out box is only 150 CNY. In this case, before releasing the information, the platform has a dedicated amount determining step to identify the amount in the upfront pricing fill-out box, which is the amount to be debited; upon a successful debit, the transaction is released; therefore, if other users viewing the information find that the compensation in the transaction description is inconsistent with the amount released by the platform in the separately set compensation entry, the latter will govern, which is also the upfront pricing actually transferred by the user to the platform.

Compared with the prior art, the transaction request according to the present disclosure is not indiscriminately pushed to all clients, but only to those clients within a specified scope. Therefore, to let a desired request reach those geographically closer users, a distance of a service provider is set to a higher priority, such that a quick service may be provided.

When a user within a certain scope receives the transaction request, he or she may determine, based on the detailed information presented by the transaction request, whether he or she is eligible to offer service, and then determine whether to offer service based on the price which is willing to be paid by the transaction request initiator and presented in the transaction request; if he or she is willing to offer service, he or she will respond to the transaction request. After responses from a plurality of users willing to offer service help have been received at the server end, one user is selected as the request-accepting vendor, who, as a service provider, provides service to the service initiator.

A conventional second hand exchange platform or a local service platform, e.g., “58.com”, generally releases a transaction request based on a priority of the information releaser. For example, when a user meets an emergent matter and needs service, he or she would escalate himself/herself to a star user or raises the price to top its search ranking so as to be viewed by more users and increase the acceptance probability. A main purpose of such platforms is to serve request-accepting parties. Various regions and various services are listed on such a platform, and the request-accepting parties would set region limitations and service conditions for screening and select a request suitable for themselves. For example, when a request of coaching a third-grade student in junior middle school in Chemistry in Complex A is released, the parent might select emergency and stick his/her post to top and more likely releases the information in the education and training sector within the reach of Complex A to wait for an appropriate chemical teacher to browse the information and then contact him or her. The present disclosure distinguishes from the conventional technical solutions in that the present disclosure is oriented to the need of the information releaser and pushes the transaction request only to clients of the users in the region limited by the releaser; such an approach of pushing transactions by region enables that the information viewed by the users is always a need within a near distance. This mode facilitates a quick response to an emergent and trivial help request. By keeping abreast of the information release platform via the client, a vendor may quickly find a service in his capability; in this way, his fragmented time may be effectively utilized, thereby realizing mutual help.

Further, according to a further embodiment of the present disclosure, the upfront pricing for the transaction minus a certain percentage of platform fee is transferred to a matched second client upon completion of the transaction.

In the present disclosure, the platform is a profiting platform and takes a certain percentage of commissions from the upfront pricing. As a profiting party, the platform is not only responsible for matching a suitable service provider for the user, but also bears certain supervision liabilities.

Further, as shown in FIG. 3, a further embodiment of the present disclosure comprises: before the step S1, accepting a registration request from a client so as to create an account for the client. The information included in the account is a basis for the user to initiate a service request or offer service; and collection and disbursement of the fees between the service provider and the transaction request initiator also need a user account so as to be implemented via direct payment from the user account or via payment from a linked third party bank account.

Furthermore, the registration request includes a user profile. The user profile of a user may be used for professional authentication such that the user has a higher probability to be selected to offer a pertinent and professional service.

Further, the user profile includes any one of individual/institution license obtained by the user, gender, age, user's ID, or credit level, or any combination of the above. When the registered user is an individual, he may upload his own personal license, e.g., medical license, driver license, teacher's qualification certificate, etc. or upload his own ID card, education degree certificate; such user information may be selectively provided, which does not affect registration; when the registered user is an institution, it may upload its own institution license, e.g., third-grade class-A hospital, specialized children's hospital, etc.

Furthermore, before creating an account for the user, the individual/institution license obtained by the user, gender, age, user's ID, or credit level, which are submitted by the user, are verified; in the case of pass, the registration succeeds; in the case of failure, the registration fails. A user having provided the user information can only be successfully registered as a qualified request-accepting user after such information is verified true and valid; then, the user may opt not to upload extra user information for registration; but once the user information is uploaded, he must ensure such information is completely true and valid for a successful registration. This practice offers an advantage that one without a qualification proof may browse a service request posted on the platform, but cannot cheat a higher compensation by uploading false qualification proof for a more professional service. Therefore, this practice may prevent a user from uploading a false user profile and preventing him or her, who does not have professional knowledge or expertise, from providing substandard professional services.

To further facilitate the transaction request initiator to select a more professional service provider, according to another preferred embodiment of the present disclosure, the transaction description further comprises a specific requirement. The steps before this operation may refer to the method steps according to any of the foregoing embodiments, which will not be detailed hereinafter.

In this embodiment, when the user initiates a service request, he also poses requirements on the professionalism of the service provider. For example, in the case of car breakdown on a roadside, when he releases a car repair request, he may add a requirement that a request responder should have a bachelor degree in chemistry major, which helps the user to clarify his own request and meanwhile reduces the probability of being unsatisfactory with the service provided by the provider prior to matching of the service.

Further, the specific requirement refers to a specific requirement on any aspect or any combination of more aspects in individual/institution license obtained by the user, gender, age, user's ID, or credit level. The specific requirement in the transaction description may be only requiring that the service provider shall have a bachelor degree in chemistry, or requiring both the bachelor degree in chemistry and female; the specific requirement may be requiring satisfaction of a single condition or simultaneous satisfaction of a plurality of conditions. The user may define various aspects of conditions for the service provider based on the transaction.

Further, the second client is further required to meet the specific requirement. In step S2, by adding a push condition with a specific requirement, the combination of the specific requirement condition and the geographical region condition may facilitate more accurately pushing the service request to a second client which has a capability to offer service and can offer service relatively quickly.

To further clarify the location of the transaction, according to a preferred embodiment of the present disclosure, the first three steps before the operation are identical to S1-S3 in FIG. 2, which will not be detailed hereinafter. Additionally, the location of the transaction is the location of the first client.

In this case, it should be clarified that the location where the user needs service is the location of the user, i.e., where the user per se meets a difficulty and needs a service. Further, the location of the first client is directly obtained by the first client enabling a positioning function or is manually entered by the user of the first client. When the user enables a privacy mode to disable positioning of the terminal, the user manually enters the location; if the positioning function of the user's terminal is enabled, the terminal position is directly obtained. Different approaches of obtaining the user's location may be adopted dependent on different privacy levels set by the user.

Another approach of further clarifying the location of the transaction is provided in a preferred embodiment of the present disclosure, the first three steps of which are identical to S1-S3 in FIG. 2 and thus will not be detailed hereinafter. Additionally, the location of the transaction refers to the location specified in the transaction request.

In this case, the help initiator may specify a certain location as the location where service is needed. It is unnecessary to limit seeking a service at a place where the transaction request initiator is located; instead, he may post a service request for other people. For example, one's old mother living at another place has a water heater to repair, but she does not know how to surf the Internet to search a repair service and it is also difficult for her to go out for searching a home appliance repair store. In this case, she may contact her son for help. At this point, the son may post a service request and designate the request to be pushed to users within a certain scope of his mother's location for seeking help.

The content above expressly specifies that the location of the transaction may be the location where the transaction request initiator is located, or a location designated by the transaction request initiator, and the scope associated with the location of the transaction is limited by the user per se. In a conventional pickup call technology, e.g., the UBER pickup platform, a pickup requester sends a pickup request to the platform; the pickup request may be requesting for a pickup for himself or for other people. Therefore, the pickup location information carried on the request may be the user's own location information or the pickup location information of the person who needs the pickup. When seeking for a matched driver for the pickup requester, the UBER platform sends an order to UBER registered drivers within a certain scope based on predetermined rules of the platform; when no one accepts the order, it will push the order to drivers within a larger scope or prompt the user to surge the price. In contrast, according to the present disclosure, all conditions are set by the request initiator. The price is fixed by the request initiator and the push scope of the information is specified by the request initiator. This practice has a higher flexibility for transaction processing. When the transaction is very urgent, the user may opt to bid highly but push the information within a smaller scope. In this case, a user who can accept the request may be nearby and can provide a quickest help; besides, a higher price can guarantee a higher request-accepting probability even the request is only pushed to a limited few.

To select a finally matched request-accepting user from the responses of one or more second clients to the service request, according to a preferred embodiment of the present disclosure, in the step S3, it may be detected whether the responding users include a user qualified for the transaction; if yes, the response from the qualified user is forwarded to the first client for selection. Besides forwarding all of the received responses to the first client such that it may select autonomously, the qualifications of all responding second clients may be first filtered to select a qualified responding second client to be further pushed to the transaction request initiator, which may improve the user filter efficiency and push the most suitable second client.

Further, after forwarding the second client to the first client to select in step S3, the method further comprises: receiving a select response of the first client to mark the status of the transaction request to Matched. By marking the status of the transaction request, the matched second client may be notified that it has been matched to become a request-accepting user, and meanwhile, other clients having received the service request may be notified that the service request task has been taken by another user.

Another approach of selecting a finally matched acceptance user from among the responses from one or more second clients to the service request is provided in a preferred embodiment of the present disclosure, the first three steps of which are identical to S1-S3 in FIG. 2 and thus will not be detailed hereinafter. Additionally, the method according to the present disclosure further comprises: in the step S3, forwarding a first response to the transaction request to the first client. At this point, the matching mechanism changes to a first-response first-accept rule, where the first second client responding to the transaction request is selected to be pushed to the first client.

Further, the method according to the present disclosure further comprises: receiving a confirm acknowledgment from the first client to mark the status of the transaction request to Matched. After pushing the response of the earliest responding second client to the first client, the first client needs to confirm the response; after confirmation by the first client, the matching is done; then, the status of the transaction request needs to be marked as Matched so as to notify the matched second client that it has been matched to become an acceptance user, and meanwhile notify other clients having received the transaction request that this service help task has been taken by another user.

Furthermore, the method further comprises: after the status of the transaction request has been marked as Matched, receiving, from the first client, a request for modifying or canceling the transaction, and forwarding the request for modifying or canceling the transaction to the matched second client; receiving an acknowledgment message from the matched second client, modifying the transaction or marking the status of the transaction request as Canceled based on the acknowledgment message; or receiving, from the matched second client, a request for canceling the transaction, forwarding the request for canceling the transaction to the first client, receiving an acknowledgment message from the first client, and marking the status of the transaction request as Canceled.

After the status of the transaction request becomes Matched, more detailed information of the transaction request initiator is presented to the request-accepting user; the transaction request initiator and the request-accepting user may communicate on the details of the service task via phone or via online. At this point, the transaction request becomes a Taken status for other users, and the other users cannot perform any operations on the transaction request. The service task having been matched to the request-accepting user are only co-managed by the service request initiator and the request-accepting user. During this period, after they have communicated on the details of the task, the service request initiator may modify or cancel the service task, e.g., increasing or decreasing the service items or temporarily change the idea to cancel the task; the service provider may also decline the offer due to harsh requirements of the counterpart and does not provide the service.

Further, after marking the status of the transaction request as Matched but before completion of the transaction, the method further comprises: receiving, from the first client, an additional payment supplemented to the transaction, and transferring a sum of the additional payment and the upfront pricing after minus a certain percentage of platform fee to the matched second client upon completion of the transaction. At this point, if during the service providing period, the service request initiator is very satisfied with the service provided by the service provider and is willing to supplement service fees thereto, the service request initiator transfers the supplemented additional fees to the platform, and the platform sums up the additional fees and the transaction payment, deducted by a certain percentage of platform fees, and then transfers the sum to the account of the service provider.

Further, after the status of the transaction request is Completed, the additional payment supplemented by the first client is received.

At this point, after the transaction request has been completed, i.e., the service task has been closed, both parties have confirmed the closure, and the payments for the transaction have been transferred to the account of the service provider, if the service request initiator intends to supplement a “compliment fee” to the service provider, he may find the completed order to supplement an additional fee to the service provider.

To solve a dispute which arises after the service has been delivered and closure thereof has been confirmed, according to one preferred embodiment of the present disclosure, as shown in FIG. 4 (which shows a flow diagram of a dispute resolution mechanism after the step S3), after the step S3, the method further comprises: receiving a dispute solution request from the client, generating vote options based on the dispute resolution request, and pushing the vote options; receiving a voting result for all vote options; and determining a payment amount based on the voting result, so as to solve a dispute arising in the case that after the service is delivered, the service request initiator is unsatisfied with the delivered service and is thus unwilling to confirm completion of the service such that the service provider cannot receive the fees for service provision. At this point, a “network arbitration” mechanism is provided. The dispute is set as a voting content which, along with vote options, is pushed to other users, such that the other users select a disposal option covered in the options; an option with the most votes is worked out as the voting result, based on which order confirmation and fee payment are performed.

Further, a voting fee is paid to voting users, wherein the voting fee is included in the upfront pricing for the transaction. Because to participate in the voting, a user needs to read transaction contents, check the reasons for the dispute, and select a most suitable disposal option after certain thinking, all of which will consume the user's mental efforts and the user's time; therefore, the voting is a paid voting. A certain fee must be paid to users participating in the voting so as to attract enough users to vote to guarantee the number of samples for the voting result, causing the voting result to satisfy a general value. Considering that the service provider only starts work after a consensus on service content and pricing has been reached with the service request initiator, the service provider generally does not raise a dispute after delivery of the service; so, the party raising the dispute can only be the service request initiator who is unsatisfied with the performance of the service provider. Therefore, it can only be the service request initiator that initiates a dispute resolution request to claim a “network arbitration,” such that it is justifiable for the service request initiator to first transfer the voting fee to the platform. Preferably, the voting fee is transferred along with the upfront pricing for the transaction. Whether to return part or all of the fee is determined based on whether the service request initiator subsequently initiates a dispute resolution request as well as the voting result after initiation of the resolution dispute.

Still further, the determining a payment amount comprises: if the voting result is that all votes support full-amount payment or full-amount refund, paying based on the voting result, wherein the dispute resolution request initiator bears the voting fee, or paying by the platform from the upfront pricing for the transaction minus the voting fee based on the voting result; if the voting result is neither supporting full-amount payment by all votes nor supporting full-amount refund by all votes, paying a certain percentage based on the voting result, wherein a responder of the dispute resolution request bears the voting fee, or paying a certain percentage by the platform from the upfront pricing for the transaction minus the voting fee based on the voting result. For example, supposing there are 101 users participating in the voting and the voting result is supporting full payment by all votes, then the service fee is directly transferred to the account of the acceptance user in full amount; and in the case that all of votes acknowledge that the acceptance user has completed the task as required, the dispute initiator shall bear, on his own, the voting fees for the dispute resolution. If the voting result is supporting full refund by all votes, as the dispute initiator has received justice and get refunds of the service fees, he should bear the voting fees, because the acceptance party has paid time, despite of being fruitless, in participating in the offer; at this time, it is unreasonable for him to bear the voting fees without getting any compensation, which is also hardly executable. Another approach is to directly deduct the voting fees from the upfront pricing for the transaction. For example, supposing the upfront pricing for the transaction is 100 CNY, once the voting is initiated, a voting fee of 10 CNY is directly deducted from the RMAB 100 yuan; when the transaction request initiator wins full votes (i.e., full refund), he gets a refund of 90 CNY; when the acceptance user wins full votes (i.e., full payment), he gets a refund of 90 CNY. When the voting manner is voting both parties (i.e., only two options) and neither of the parties wins full supports, the vote ratio between the two parties may be worked out to determine the actual service fee paid to the acceptance party. For example, supposing the upfront pricing is 101 CNY, and the ratio between the votes of the acceptance party and the votes of the request initiator is 85:16, then the actual service fee is 101×85/(85+16)=85 CNY, and the finally paid fee refers to the actual service fee minus the voting fee liable to the acceptance party. When the voting manner is that a plurality of options of payment ratios have been set, the payment is made based on the payment ratio with the highest votes. For example, supposing that the upfront pricing is 100 CNY and 85 users participate in the voting, wherein 12 vote for full payment, 46 vote for paying 80%, 21 vote for paying 60%, 3 vote for paying 40%, 2 vote for paying 20%, and 0 vote for full refund; then, the payment is made according to 80%, the option with the highest votes; the final payment is deducted by the voting fee liable to the acceptance party. A further payment manner is to first deduct the voting fee from the upfront pricing for the transaction. For example, assuming the upfront pricing for the transaction is 100 CNY, then the voting fee of 100 CNY is deducted by the platform; the remaining 90 CNY is allocated between the transaction request initiator and the acceptance user based on the vote ratio. For example, the ratio between votes of the acceptance party and the votes of the transaction request initiator is 6:4, then the compensation attributed to the acceptance party=(100−10)×(6/(6+4))=54, and the refund attributable to the transaction request initiator=(100−10)×(4/(6+4))=36.

It may be understood from the description above that in the present disclosure, by pushing a transaction request to specified users within a certain range, only those users within the specified range can respond, such that a potential responding user can quickly handle the transaction request due to geographical location advantages; meanwhile, upon user registration, a user profile authentication mechanism is provided, such that by adding qualification filtering conditions, for the transaction request with a qualification requirement, a responder who is more competent for the transaction request may be selected; the platform provides a transaction guarantee, where a network voting mechanism is provided for a dispute between the parties to the transaction on the fees to pay after the user posting the transaction request and the responding user are successfully matched and the acceptance party has delivered the service; rules for paid voting are set, such that how to pay the fees is determined based on the voting result. The present disclosure implements a mechanism of matching a response to an emergent and trivial service demand; besides, the responder may quickly reach the location of the demand to provide service; the qualification requirements may also single out a responder who is more competent in helping the demand; and the subsequent dispute resolution mechanism as provided provides a reasonable resolution to the payment dispute between the parties arising from unsatisfaction with performance of the service.

FIG. 5 shows an apparatus for matching between a transaction request and a response based on location of a transaction according to another aspect of the present disclosure, the apparatus comprising: a first unit configured for receiving, by a server, a transaction request from a first client, the transaction request including a transaction description, an upfront pricing for the transaction, location of the transaction, and a posting scope associated with the location of the transaction; a second unit configured for: after a receiver in the server successfully receives the upfront pricing for the transaction transferred from the first client, positioning, via a Location Based Service (LBS), locations of other clients based on the location of the transaction, and pushing the transaction request to a plurality of second clients within the posting scope; and a third unit configured for receiving, from one or more of the plurality of second clients, one or more responses to the request, and forwarding the one or more responses to the first client to implement matching.

Further, the upfront pricing for the transaction minus a certain percentage of platform fee is transferred to a matched second client upon completion of the transaction.

Further, as shown in FIG. 6, the apparatus further comprises a fourth unit, configured for accepting a registration request from a client so as to create an account for the client.

Further, the registration request includes a user profile.

Further, the user profile includes any one of individual/institution license obtained by the user, gender, age, user's ID, or credit level, or any combination of the above.

Furthermore, before creating an account for the user, the individual/institution license obtained by the user, gender, age, user's ID, or credit level, which are submitted by the user, are verified; in the case of pass, the registration succeeds; in the case of failure, the registration fails.

According to another embodiment of the present disclosure, the transaction description further includes a specific requirement, as shown in FIG. 4.

Further, the specific requirement refers to a specific requirement on any aspect or any combination of more aspects in individual/institution license obtained by the user, gender, age, user's ID, or credit level, or any combination of the above.

Further, in the second unit, the second client is further required to meet the specific requirement.

According to another embodiment of the present disclosure, the location of the transaction is the location of the first client, as shown in FIG. 5.

Further, the location of the first client is directly obtained by the first client which enables a positioning function or is manually entered by the user of the first client.

According to another embodiment of the present disclosure, the location of the transaction is a location specified in the transaction request, as shown in FIG. 5.

According to another embodiment of the present disclosure, the third unit is further configured for forwarding a plurality of responses to the transaction request to the first client for selection, as shown in FIG. 5.

According to another embodiment of the present disclosure, the third unit is further configured for receiving a select response from the first client, and marking a status of the transaction request as Matched, as shown in FIG. 5.

According to another embodiment of the present disclosure, the third unit is further configured for: detecting whether responding users include a user qualified for the transaction; if yes, forwarding the response from the qualified user to the first client for selection, as shown in FIG. 5.

Further, the third unit is further configured for: receiving a select response from the first client, and marking a status of the transaction request as Matched.

According to another embodiment of the present disclosure, the third unit is further configured for forwarding a first response to the transaction request to the first client, as shown in FIG. 5.

Further, the third unit is further configured for: receiving an acknowledgment response from the first client, and marking the status of the transaction request as Matched.

Even further, the third unit is configured for: after the status of the transaction request has been marked as Matched, receiving, from the first client, a request for modifying or canceling the transaction, and forwarding the request for modifying or canceling the transaction to the matched second client; receiving an acknowledgment message from the matched second client, modifying the transaction or marking the status of the transaction request as Canceled based on the acknowledgment message; or receiving, from the matched second client, a request for canceling the transaction and forwarding the request for canceling the transaction to the first client, receiving an acknowledgment message from the first client, and marking the status of the transaction request as Canceled.

Still further, after marking the status of the transaction request as Matched but before completion of the transaction, the third unit is further configured for: receiving, from the first client, an additional payment supplemented to the transaction, and transferring a sum of the additional payment and the upfront pricing after minus a certain percentage of platform fee to the matched second client upon completion of the transaction.

Further, after the status of the transaction request is Completed, the additional payment supplemented by the first client is received.

According to a preferred embodiment of the present disclosure, the first three steps of which are identical to S1-S3 in FIG. 2 and thus will not be detailed hereinafter, the apparatus of the present disclosure further comprises a fifth unit, the fifth unit including: a first subunit configured for receiving a dispute solution request from the client; a second subunit configured for generating vote options based on the dispute resolution request, and pushing the vote options; and a third subunit configured for receiving a voting result for all vote options and determining a payment amount based on the voting result.

Further, a voting fee is paid to a voting user, the voting fee being included in the upfront pricing for the transaction.

Still further, the determining a payment amount comprises: if the voting result is that all votes support full-amount payment or full-amount refund, paying based on the voting result, wherein the dispute resolution request initiator bears the voting fee, or paying by the platform from the upfront pricing for the transaction minus the voting fee based on the voting result; if the voting result is neither supporting full-amount payment by all votes nor supporting full-amount refund by all votes, paying a certain percentage based on the voting result, wherein a responder of the dispute resolution request bears the voting fee, or paying a certain percentage by the platform from the upfront pricing for the transaction minus the voting fee based on the voting result.

Those skilled in the art may understand that various aspects of the present disclosure may be implemented as a system, a method or a program product. Therefore, various aspects of the present disclosure may be specifically implemented in the following manners: complete hardware, complete software (including firmware and microcode, etc.), or a combination of hardware and software, which may be generally referred to as “a circuit,” “a module,” or “a system.”

In some other alternative embodiments, the present disclosure may be implemented as a server, the server may comprise: a memory; a processor coupled to the memory, wherein the processor is configured for executing, based on an instruction stored in the memory, the method as above mentioned.

Hereinafter, FIG. 8 will be referenced to describe a server according to such an embodiment of the present disclosure. As shown in FIG. 8, the server 1 is embodied in a general computing device form, including, but not limited to: at least one processor 10, at least one memory 20, and a bus 60 connecting different system components.

The bus 60 may represent one or more of several kinds of bus structures, including a memory bus or a memory unit controller, a peripheral bus, a graphical acceleration port, a processor, or a local area bus using any bus structure(s) in a plurality of bus structures.

The memory 20 may comprise a readable medium in a volatile memory unit form, e.g., a random access memory (RAM) 21 and/or a cache memory 22; it may further comprise a read-only memory (ROM) 23.

The memory 20 may further comprise a program module 24. Such program module 24 includes, but is not limited to: an operating system, one or more applications, other program modules and program data, wherein each or a certain combination in these examples possibly includes implementation in a network environment.

The server 1 may further communicate with one or more peripheral devices 2 (e.g., a keyboard, a pointing device, a Bluetooth device, etc.) or communicate with one or more other devices. Such communication may be performed via an input/output (I/O) interface 40 and presented on a display unit 30. Moreover, the server 1 may further communicate with one or more networks (e.g., a local area network (LAN), a wide area network (WAN), and/or a public network, e.g., the Internet) via a network adapter 50. As shown in the figure, the network adapter 50 may communicate with other modules of the server 1 via the bus 60. It should be understood that although not shown in the figure, other hardware and/or software modules may be used in conjunction with the server 1, including, but not limited to, microcode, a device driver, a redundancy processing unit, an external disk driving array, an RAID system, a tape driver, and a data backup storage system, etc.

In some alternative embodiments, various aspects of the present disclosure may be further implemented into a form of program product, comprising program code; when the program code is executed by the processor, the program code may be used for actuating the processor to execute the method described above.

The program product may adopt any combination of one or more readable mediums. The readable medium may be a readable signal medium or a readable storage medium. The readable storage medium, for example, may be, but is not limited to, an electrical, magnetic, optical, electromagnetic, infrared, or semiconductor system, apparatus or device, or any combination thereof. More specific examples (a non-exhaustive list) of the computer-readable storage medium may include an electrical connection having one or more wires, a portable magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

Now refer to FIG. 9. FIG. 9 describes a program product 3 according to the embodiments of the present disclosure, which may be stored on a CD-ROM and comprises program code, and may be run on a terminal device, for example, a personal computer. However, the program product of the present disclosure is not limited thereto. In the present disclosure, the computer-readable storage medium may be any tangible medium containing or storing a program that may be used by an instruction executing system, apparatus, or device or used in combination therewith.

Program code for carrying out operations of the present disclosure may be compiled in any combination of one or more programming languages, the programming languages including object-oriented programming languages such as Java, C++ or the like, as well as conventional procedural programming languages, such as the “C” programming language or similar programming languages. The program code may be executed entirely on a user computing device, partially on the user's computer, executed as a stand-alone software package, and partially on the user's computer and partially executed on a remote computer, or entirely executed on the remote computer or server. In a scenario involving a remote computing device, the remote computing device may be connected to the user's computing device through any type of network, including a local area network (LAN) or a wide area network (WAN), or the connection may be made to an external computing device (for example, through the Internet using an Internet Service Provider).

Additionally, although the operations of the method of the present disclosure have been described according to a certain sequence in the drawings, this does not compulsorily require or imply that these operations must be executed according to that sequence, or a desired result can only be achieved after all of the presented operations have been completely performed. additionally, or alternatively, some steps may be omitted; multiple steps may be merged into one step; and/or one step may be divided into multiple steps to execute.

It should be noted that, the examples above are intended to illustrate the present disclosure, not to limit the present disclosure. Without departing from the scope of the claims, those skilled in the art may devise alternative examples. In the claims, no reference numerals placed in the parentheses should be construed as any limitation to the claims.

What is claimed is:

1. A method for matching between a transaction request and a response based on location of a transaction, comprising:
step S1: receiving, by a server, a transaction request from a first client, the transaction request including a transaction description, an upfront pricing for the transaction, location of the transaction, and a posting scope associated with the location of the transaction;
step S2: after a receiver in the server successfully receives the upfront pricing for the transaction transferred from the first client, positioning, via a Location Based Service (LBS), locations of other clients based on the location of the transaction, and pushing the transaction request to a plurality of second clients within the posting scope, and
step S3: receiving, from one or more of the plurality of second clients, one or more responses to the transaction request, and forwarding the one or more responses to the first client to implement matching.

2. The method according to claim 1, wherein the upfront pricing for the transaction minus a certain percentage of platform fee is transferred to a matched second client upon completion of the transaction.

3. The method according to claim 2, further comprising:
before step S1, accepting a registration request from a client so as to create an account for the client;
the registration request includes a user profile;
the user profile includes any one of individual/institution license obtained by the user, gender, age, user's ID, or credit level, or any combination of the above.

4. The method according to claim 1, wherein the transaction description further includes a specific requirement;
the specific requirement refers to a specific requirement on any aspect or any combination of more aspects in individual/institution license obtained by the user, gender, age, user's ID, or credit level, or any combination of the above.

5. The method according to claim 1, wherein the location of the transaction refers to a location of the first client, or the location of the transaction refers to a location specified in the transaction request;
the location of the first client is directly obtained by the first client which enables a positioning function or is manually entered by the user of the first client.

6. The method according to claim 1, wherein the step S3 further comprises forwarding a plurality of responses to the transaction request to the first client for selection, or detecting whether responding users include a user qualified for the transaction; if yes, forwarding the response from the qualified user to the first client for selection.

7. The method according to claim 1, wherein the step S3 further comprises: forwarding the first response to the transaction request to the first client;
receiving an acknowledgment response from the first client, and marking the status of the transaction request as Matched.

8. The method according to claim 7, further comprising: after the status of the transaction request has been marked as Matched,
receiving, from the first client, a request for modifying or canceling the transaction, and forwarding the request for modifying or canceling the transaction to the matched second client;
receiving an acknowledgment message from the matched second client, modifying the transaction or marking the status of the transaction request as Canceled based on the acknowledgment message; or
receiving, from the matched second client, a request for canceling the transaction, forwarding the request for canceling the transaction to the first client, receiving an acknowledgment message from the first client, and marking the status of the transaction request as Canceled.

9. The method according to claim 7, further comprising: after marking the status of the transaction request as Matched but before completion of the transaction, the method further comprises: receiving, from the first client, an additional payment supplemented to the transaction, and transferring a sum of the additional payment and the upfront pricing after minus a certain percentage of platform fee to the matched second client upon completion of the transaction.

10. The method according to claim 1, further comprising: after the step S3,
receiving a dispute resolution request from the client,
generating vote options based on the dispute resolution request, and pushing the vote options;
receiving a voting result for all vote options;
and determining a payment amount based on the voting result.

11. The method according to claim 10, wherein the determining a payment amount comprises:
if the voting result is that all votes support full-amount payment or full-amount refund, paying based on the voting result, wherein the dispute resolution request initiator bears the voting fee, or paying by the platform from the upfront pricing for the transaction minus the voting fee based on the voting result; and
if the voting result is neither supporting full-amount payment by all votes nor supporting full-amount refund by all votes, paying a certain percentage based on the voting result, wherein a responder of the transaction request bears the voting fee, or paying a certain percentage by the platform from the upfront pricing for the transaction minus the voting fee based on the voting result.

12. An apparatus for matching between a transaction request and a response based on location of a transaction, comprising:
a first unit configured for receiving, by a server, a transaction request from a first client, the transaction request including a transaction description, an upfront pricing for the transaction, location of the transaction, and a posting scope associated with the location of the transaction;
a second unit configured for: after a receiver in the server successfully receives the upfront pricing for the transaction transferred from the first client, positioning, via a Location Based Service (LBS), locations of other clients based on the location of the transaction, and pushing the transaction request to a plurality of second clients within the posting scope;
and a third unit configured for receiving, from one or more of the plurality of second clients, one or more responses to the transaction request, and forwarding the one or more responses to the first client to implement matching.

13. The apparatus according to claim 12, further comprising:
a fourth unit configured for accepting a registration request from a client so as to create an account for the client.

14. The apparatus according to claim 12, wherein the third unit is further configured for: detecting whether responding users include a user qualified for the transaction; if yes, forwarding the response from the qualified user to the first client for selection;
the third unit is further configured for receiving a select response from the first client, and marking a status of the transaction request as Matched, or the third unit is further configured for forwarding a first response to the transaction request to the first client.

15. The apparatus according to claim 14, wherein the third unit is further configured for: receiving an acknowledgment response from the first client, and marking the status of the transaction request as Matched.

16. The apparatus according to claim 14, wherein the third unit is further configured for: after the status of the transaction request has been marked as Matched,
receiving, from the first client, a request for modifying or canceling the transaction, and forwarding the request for modifying or canceling the transaction to the matched second client;
receiving an acknowledgment message from the matched second client, modifying the transaction or marking the status of the transaction request as Canceled based on the acknowledgment message; or
receiving, from the matched second client, a request for canceling the transaction, forwarding the request for canceling the transaction to the first client, receiving an acknowledgment message from the first client, and marking the status of the transaction request as Canceled.

17. The apparatus according to claim 14, wherein:
after marking the status of the transaction request as Matched but before completion of the transaction, the third unit is further configured for: receiving, from the first client, an additional payment supplemented to the transaction, and transferring a sum of the additional payment and the upfront pricing after minus a certain percentage of platform fee to the matched second client upon completion of the transaction.

18. The apparatus according to claim 12, further comprising a fifth unit, wherein the fifth unit includes:
a first subunit configured for receiving a dispute resolution request from the client;
a second subunit configured for generating vote options based on the dispute resolution request, and pushing the vote options; and
a third subunit configured for receiving a voting result for all vote options and determining a payment amount based on the voting result.

19. A computer-readable memory medium on which a computer program is stored, wherein the computer program, when being executed by one or more processors, implements the method according to claim 1.
